(19) United States
(12) Patent Application Publication
(10) Pub. No.: US 2009/0081526 A1
(43) Pub. Date: Mar. 26, 2009

(54) ELECTRODE FOR FUEL CELL AND FUEL CELL SYSTEM INCLUDING SAME

(76) Inventors: Ji-Seok Hwang, Suwon-si (KR); Min-Kyu Song, Suwon-si (KR); You-Mee Kim, Suwon-si (KR); Hyoung-Seok Song, Suwon-si (KR); Hyun-Seok Cho, Suwon-si (KR)

Correspondence Address: CHRISTIE, PARKER & HALE, LLP, PO BOX 7068, PASADENA, CA, 91109-7068, US

(21) Appl. No.: 12/174,034

(22) Filed: Jul. 16, 2008

(30) Foreign Application Priority Data
Sep. 20, 2007 (KR) 10-2007-0096105

(51) Int. Cl. H01M 4/00

(52) U.S. Cl. 429/40

(57) ABSTRACT

An electrode for a fuel cell and a fuel cell system including the electrode. The electrode includes an electrode substrate including carbon fiber and a hydrophobic polymer fiber, and a catalyst layer on the electrode substrate. As such, the electrode uniformly includes the hydrophobic polymer fiber thereon, and therefore can uniformly release and maintain water generated during operation of the fuel cell, thereby improving fuel cell characteristics.

### CROSS-REFERENCE TO RELATED APPLICATION

This application claims priority to and the benefit of Korean Patent Application No. 10-2007-0096105, filed in the Korean Intellectual Property Office, on Sep. 20, 2007, the entire contents of which are incorporated herein by reference.

### BACKGROUND OF THE INVENTION

1. Field of the Invention

The present invention relates to an electrode for a fuel cell and a fuel cell system including the same.

2. Description of the Related Art

A fuel cell system (or fuel cell) is a power generation system for producing electrical energy through an electrochemical redox reaction of an oxidant and a fuel, such as hydrogen or a hydrocarbon-based material, such as methanol, ethanol, natural gas, and the like. In addition, a fuel cell system is a clean energy source that can replace systems using fossil fuels (or fossil fuel type power generation systems). A fuel cell system includes a stack composed of unit cells and produces various ranges of power output. Since a fuel cell system has from about four to about ten times more energy density than a small lithium battery, it has been spotlighted as a small portable power source that can replace lithium battery.

Representative exemplary fuel cell systems include a polymer electrolyte membrane fuel cell (PEMFC) system and a direct oxidation fuel cell (DOFC) system. The direct oxidation fuel cell includes a direct methanol fuel cell that uses methanol as a fuel. The polymer electrolyte fuel cell has relatively high energy density and high power, but needs careful handling of hydrogen gas and accessory facilities such as a fuel reforming processor for reforming methane or methanol, natural gas, and the like in order to produce the hydrogen gas as a fuel.

In contrast, a direct oxidation fuel cell has lower energy density than that of the polymer electrolyte fuel cell, but it uses a liquid-type fuel that can be easily handled, has a low operation temperature, and needs no additional fuel reforming processor. In the above-mentioned fuel cell system, a stack that substantially generates electricity includes several to scores of unit cells stacked adjacent to one another, and each unit cell is formed of a membrane-electrode assembly (MEA) and a separator (also referred to as a bipolar plate).

The membrane-electrode assembly is composed of an anode (also referred to as a “fuel electrode” or an “oxidation electrode”) and a cathode (also referred to as an “air electrode” or a “reduction electrode”) that are separated by a polymer electrolyte membrane. Electricity is generated as follows. A fuel is supplied to the anode and adsorbed on catalysts of the anode, and then oxidized to produce protons and electrons. The electrons are transferred into the cathode via an external circuit, and the protons are transferred into the cathode through the polymer electrolyte membrane. In addition, an oxidant is supplied to the cathode. Then the oxidant, protons, and electrons react with one another on catalysts of the cathode to produce electricity along with water.

### SUMMARY OF THE INVENTION

Aspects of embodiments of the present invention are directed toward a fuel cell electrode that is subjected to a uniform water-repellent treatment, and/or that is capable of improving fuel cell performance; and a fuel cell system including the same and/or having positive fuel cell characteristics.

An embodiment of the present invention provides an electrode for a fuel cell that includes an electrode substrate including a carbon fiber and a hydrophobic polymer fiber, and a catalyst layer on the electrode substrate.

Another embodiment of the present invention provides a fuel cell system that includes at least one electricity generating element (or electrical generator) including a membrane-electrode assembly and generating electricity through electrochemical reaction of a fuel and an oxidant, the membrane-electrode assembly including an anode, a cathode facing the anode, and a separator interposed between the anode and the cathode, at least one of the anode or the cathode including an electrode substrate and a catalyst layer; a fuel supplier supplying the at least one electricity generating element with a fuel; and an oxidant supplier supplying the electricity generating element with an oxidant. Here, the electrode substrate includes a carbon fiber and a hydrophobic polymer fiber.

Since a hydrophobic polymer is uniformly included on an electrode substrate as a fiber according to an embodiment of the present invention, the electrode substrate can uniformly maintain and discharge water generated during operation of a fuel cell, thereby improving fuel cell characteristics.

### BRIEF DESCRIPTION OF THE DRAWING

The accompanying drawing, together with the specification, illustrate exemplary embodiments of the present invention, and, together with the description, serve to explain the principles of the present invention.

FIG. 1 is a drawing showing an electrode substrate (a) in which a carbon fiber is weaved with a hydrophobic polymer fiber, as well as an enlarged drawing (b) of the electrode substrate (a); and

FIG. 2 is a schematic view showing a fuel cell system according to an embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Also, in the context of the present application, when an element is referred to as being “on” another element, it can be directly on the another element or be indirectly on the another element with one or more intervening elements interposed therebetween. Like reference numerals designate like elements throughout the specification.

An embodiment of the present invention relates to an electrode for a fuel cell, and particularly to an electrode substrate. In a fuel cell, an electrode substrate plays a role of supporting an electrode and diffusing a fuel and an oxidant into a catalyst layer so that the fuel and the oxidant can easily reach the catalyst layer, and also of collecting a current generated from the catalyst layer and delivering the current to a separator.

A conventional electrode substrate includes a conductive material. For example, the electrode substrate includes carbon paper, carbon cloth, or carbon felt.

In addition, the electrode substrate is treated with a water-repellent in order to prevent (or reduce) diffusion efficiency deterioration of a reactant due to water generated during operation of a fuel cell.

The water-repellent treatment is performed by repeatedly depositing a fluorine-base resin emulsion on a conductive substrate to regulate the loading amount of the fluorine-based resin. However, since the carbon paper, carbon cloth, or carbon felt is formed of carbon fiber with high hygroscopicity, it is difficult to uniformly disperse a fluorine-based resin on an electrode substrate as well as to regulate the loading amount thereof. As such, the electrode substrate may not be capable of uniformly releasing water generated from the electrode during operation of a fuel cell. As a result, the electrode may be flooded by water, which increases mass transfer resistance of a reactant and thereby deteriorates cell performance.

An embodiment of the present invention provides an electrode for a fuel cell not having the above problem.

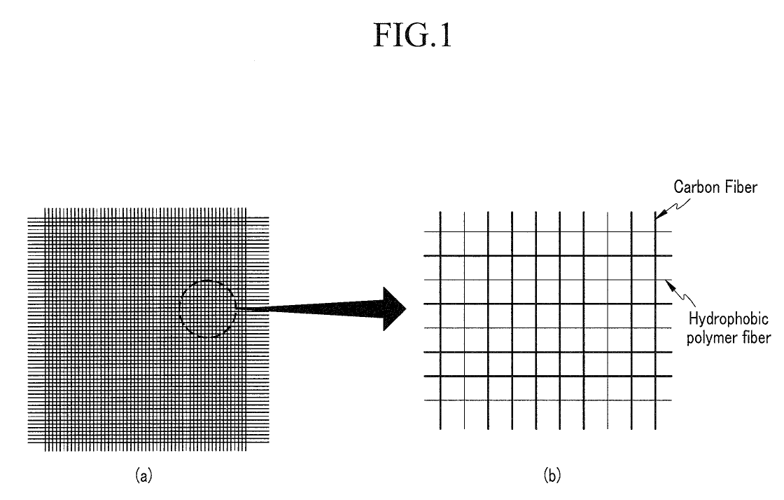

According to an embodiment of the present invention, an electrode for a fuel cell includes an electrode substrate and a catalyst layer disposed thereon. The electrode substrate includes a carbon fiber and a hydrophobic polymer fiber. The carbon 10 fiber is weaved with the hydrophobic polymer fiber, as shown in (a) of FIG. 1 and enlarged drawing ((b) of FIG. 1) thereof.

The hydrophobic polymer fiber has an average diameter ranging from about 100 nm to about 10 μm (or from 100 nm to 10 μm). In another embodiment, the hydrophobic polymer fiber has an average diameter ranging from about 100 nm to about 1 μm (or from 100 nm to 1 μm). In one embodiment, the hydrophobic polymer fiber with an average diameter ranging from 100 nm to 10 μm can accomplish the desirable water repellency.

According to an embodiment of the present invention, unlike a hydrophobic polymer fiber, the average diameter of a carbon fiber does not have much influence on water repellency.

The carbon fiber may be mixed with the hydrophobic polymer fiber in a ratio ranging from about 99:1 to about 50:50 wt % (or from 99:1 to 50:50 wt %). In another embodiment, the mixing ratio ranges from about 95:5 to about 80:20 wt % (or from 95:5 to 80:20 wt %). In one embodiment, when the hydrophobic polymer fiber is included in an amount ranging from 1 to 50 wt %, the hydrophobic polymer fiber can contribute to water repellency by regulating a water-repellent treatment rate.

The hydrophobic polymer fiber may include, but is not limited to, a fiber including a resin selected from the group consisting of polytetrafluoroethylene, polyvinylidene fluoride, polyhexafluoropropylene, polyperfluoroalkylvinylether, polyperfluorosulfonylfluoride alkoxyvinyl ether, fluorinated ethylene propylene, polychlorotrifluoroethylene, copolymers thereof, and combinations thereof.

A conventional depositing method has caused a problem of not uniformly discharging water, because a fluorine-based resin is variably loaded in a depth direction. Accordingly, an embodiment of the present invention provides an electrode substrate prepared by weaving a hydrophobic polymer fiber, so that the hydrophobic polymer can be uniformly included even in a depth direction. In addition, when a fluorine-based resin is conventionally deposited on an electrode substrate, there is a problem that the fluorine-based resin cannot be uniformly distributed thereon. However, when an electrode substrate of an embodiment of the present invention is prepared by weaving a hydrophobic polymer with a carbon fiber, the hydrophobic polymer can be uniformly distributed, thereby providing a uniform water-discharge rate for the electrode substrate.

In addition, a microporous layer (MPL) can be added between the aforementioned electrode substrate and a catalyst layer to increase reactant diffusion effects. The microporous layer generally includes conductive powders with a certain (or set) particle diameter. The conductive material of the microporous layer may include, but is not limited to, carbon powder, carbon black, acetylene black, ketjen black, activated carbon, carbon fiber, fullerene, nano-carbon, or combinations thereof. The nano-carbon may include a material such as carbon nanotubes, carbon nanofiber, carbon nanowire, carbon nanohorns, carbon nanorings, or combinations thereof.

The microporous layer is formed by coating a composition including a conductive powder, a binder resin, and a solvent on the conductive substrate. The binder resin may include, but is not limited to, polytetrafluoroethylene, polyvinylidenefluoride, polyhexafluoropropylene, polyperfluoro alkylvinylether, polyperfluorosulfonylfluoride, alkoxyvinyl ether, polyvinylalcohol, cellulose acetate, or copolymers thereof. The solvent may include, but is not limited to, an alcohol such as ethanol, isopropyl alcohol, n-propyl alcohol, butanol, and so on, water, dimethyl acetamide, dimethyl sulfoxide, N-methylpyrrolidone, and/or tetrahydrofuran. The coating method may include, but is not limited to, screen printing, spray coating, doctor blade methods, gravure coating, dip coating, silk screening, painting, and so on, depending on the viscosity of the composition.

The catalyst layer can include any suitable catalyst for participating in a fuel cell reaction, for example a platinum-based catalyst. The platinum-based catalyst may be platinum, ruthenium, osmium, a platinum-ruthenium alloy, a platinum-osmium alloy, a platinum-palladium alloy, and/or a platinum-M alloy (wherein M is at least one transition element selected from the group consisting of Ga, Ti, V, Cr, Mn, Fe, Co, Ni, Cu, Zn, Sn, Mo, W, Rh, and Ru). As mentioned above, an anode and a cathode may include the same material. However, a direct oxidation fuel cell may include a platinum-ruthenium alloy catalyst as an anode catalyst in order to prevent (or reduce) catalyst poisoning due to CO generated during the anode reaction. Representative examples of the catalysts include Pt, Pt/Ru, Pt/W, Pt/Ni, Pt/Sn, Pt/Mo, Pt/Pd, Pt/Fe, Pt/Cr, Pt/Co, Pt/Ru/W, Pt/Ru/Mo, Pt/RuN, Pt/Fe/Co, Pt/Ru/Rh/Ni, and/or Pt/Ru/Sn/W.

Such a catalyst may be used in a form as a metal itself (black catalyst), or can be used while being supported on a carrier. The carrier may include carbon such as graphite, denka black, ketjen black, acetylene black, carbon nanotubes, carbon nanofiber, carbon nanowire, carbon nanoballs, activated carbon, and so on, or an inorganic material (or particulate) such as alumina, silica, zirconia, titania, and so on. In one embodiment, the carrier is formed using carbon. A noble metal supported on a carrier may be a commercially available one or can be prepared by supporting a noble metal on a carrier. A suitable method is used for supporting the noble metal on the carrier.

The catalyst layer may further include a binder resin to improve its adherence and proton transfer properties.

The binder resin may be a proton conductive polymer resin having a cation exchange group selected from the group consisting of a sulfonic acid group, a carboxylic acid group, a phosphoric acid group, a phosphonic acid group, and derivatives thereof at its side chain. Non-limiting examples of the polymer of the binder resin include at least one proton conductive polymer selected from the group consisting of perfluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In one embodiment, the proton conductive polymer is at least one proton conductive polymer selected from the group consisting of poly(perfluorosulfonic acid), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly(2,5-benzimidazole).

The hydrogen (H) in the cation exchange group of the proton conductive polymer can be substituted with Na, K, Li, Cs, or tetrabutylammonium. When the H in the cation exchange group of the terminal end of the proton conductive polymer side chain is substituted with Na or tetrabutylammonium, NaOH or tetrabutylammonium hydroxide may be used during preparation of the catalyst composition, respectively. When the H is substituted with K, Li, or Cs, suitable compounds for the substitutions may be used.

The binder resins may be used singularly or in combination. They may be used along with non-conductive polymers to improve adherence with a polymer electrolyte membrane. The binder resins may be used in a controlled amount to adapt to their purposes.

Non-limiting examples of the non-conductive polymers include polytetrafluoroethylene (PTFE), tetrafluoroethylene-hexafluoropropylene copolymers (FEP), tetrafluoroethylene-perfluoro alkylvinylether copolymers (PFA), ethylene/tetrafluoroethylene (ETFE), chlorotrifluoroethylene-ethylene copolymers (ECTFE), polyvinylidenefluoride, polyvinylidenefluoride-hexafluoropropylene copolymers (PVdF-HFP), dodecylbenzenesulfonic acid, sorbitol, and combinations thereof.

According to one embodiment of the present invention, an electrode for a fuel cell can be used as an anode or a cathode in a membrane-electrode assembly. According to another embodiment of the present invention, a membrane-electrode assembly includes an anode and a cathode, and a polymer electrolyte membrane interposed between the cathode and the anode.

The anode and/or the cathode may have the electrode structure as above.

The polymer electrolyte membrane functions as an ion-exchange member to transfer protons generated in an anode catalyst layer to a cathode catalyst layer. In one embodiment, the polymer electrolyte membrane of the membrane-electrode assembly includes a proton conductive polymer resin. The proton conductive polymer resin may be a polymer resin having a cation exchange group selected from the group consisting of a sulfonic acid group, a carboxylic acid group, a phosphoric acid group, a phosphonic acid group, and derivatives thereof, at its side chain.

Non-limiting examples of the polymer resin include fluoro-based polymers, benzimidazole-based polymers, polyimide-based polymers, polyetherimide-based polymers, polyphenylenesulfide-based polymers polysulfone-based polymers, polyethersulfone-based polymers, polyetherketone-based polymers, polyether-etherketone-based polymers, and polyphenylquinoxaline-based polymers. In one embodiment, the proton conductive polymer of the polymer resin is at least proton conductive polymer selected from the group consisting of poly(perfluorosulfonic acid) (NAFION™), poly(perfluorocarboxylic acid), a copolymer of tetrafluoroethylene and fluorovinylether having a sulfonic acid group, defluorinated polyetherketone sulfide, aryl ketone, poly(2,2′-(m-phenylene)-5,5′-bibenzimidazole), and poly(2,5-benzimidazole). The hydrogen (H) in the proton conductive group of the proton conductive polymer can be substituted with Na, K, Li, Cs, or tetrabutylammonium. When the H in the ionic exchange group of the terminal end of the proton conductive polymer side is substituted with Na or tetrabutylammonium, NaOH or tetrabutylammonium hydroxide may be used, respectively. When the H is substituted with K, Li, or Cs, suitable compounds for the substitutions may be used.

In one embodiment of the present invention, a fuel cell system including the above described membrane-electrode assembly also includes at least one electricity generating element (or electrical generator), a fuel supplier, and an oxidant supplier.

The electricity generating element includes a membrane-electrode assembly and a separator. The membrane-electrode assembly includes a polymer electrolyte membrane, and a cathode and an anode disposed at opposite sides of the polymer electrolyte membrane. The electricity generating element generates electricity through oxidation of a fuel and reduction of an oxidant.

The fuel supplier plays a role of supplying the electricity generating element with a fuel. The oxidant supplier plays a role of supplying the electricity generating element with an oxidant such as oxygen or air.

The fuel includes liquid or gaseous hydrogen, or a hydrocarbon-based fuel such as methanol, ethanol, propanol, butanol, or natural gas.

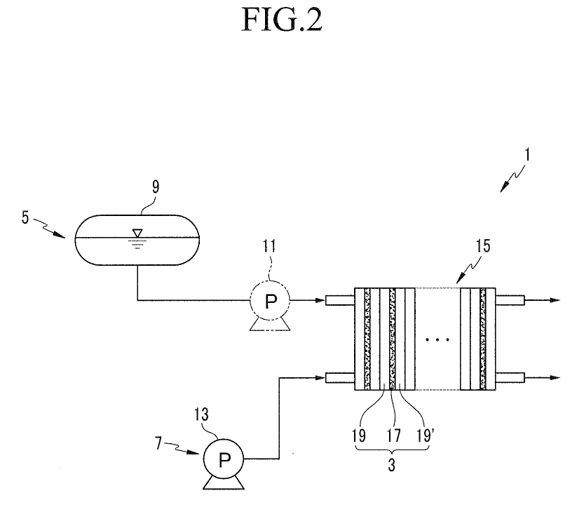

FIG. 2 is a schematic structure of a fuel cell system that will be described in more detail. FIG. 2 illustrates a fuel cell system wherein a fuel and an oxidant are provided to an electricity generating element (or electrical generator) through pumps, but the present invention is not limited to such structures. The fuel cell system according to an embodiment of the present invention alternatively includes a structure wherein a fuel and an oxidant are provided in a diffusion manner.

A fuel cell system 1 includes one or more electricity generating elements (or electrical generators) 3. The electricity generating element 3 generates electrical energy through an electrochemical reaction of a fuel and an oxidant. In addition, the fuel cell system 1 includes a fuel supplier 5 for supplying a fuel to the electricity generating element 3, and an oxidant supplier 7 for supplying an oxidant to the electricity generating element 3.

In addition, the fuel supplier 5 is equipped with a tank 9 that stores a fuel, and a fuel pump 11 that is connected therewith. The fuel pump 11 supplies fuel stored in the tank 9 with a pumping power that may be predetermined.

The oxidant supplier 7, which supplies the electricity generating element 3 with an oxidant, is equipped with one or more pumps 13 for supplying an oxidant with a pumping power that may be predetermined.

The electricity generating element 3 includes a membrane-electrode assembly 17, which oxidizes hydrogen or a fuel and reduces an oxidant, and separators 19 and 19′ that are respectively positioned at opposite sides of the membrane-electrode assembly 17 and supply hydrogen (or a fuel) and an oxidant, respectively. In one embodiment, the electricity generating elements 3 are stacked to form a stack 15.

The following examples illustrate the present invention in more detail. However, the present invention is not limited by these examples.

### EXAMPLE 1

A carbon-cloth electrode substrate was fabricated by weaving a polytetrafluoroethylene yarn with an average diameter of 100 nm and a carbon fiber in a ratio of 5:95 wt %.

Next, a catalyst composition for an anode was prepared by mixing 88 wt % of a Pt-Ru black (Johnson Mafthey) catalyst and 12 wt % of NAFION/H₂O/2-propanol (Solution Technology Inc.) in a 5 wt % concentration as a binder. A catalyst composition for a cathode was prepared by mixing 88 wt % of a Pt black (Johnson Matthey) catalyst and 12 wt % of NAFION/H₂O/2-propanol (Solution Technology Inc.) in a 5 wt % concentration as a binder. They were respectively coated on the carbon clothe electrode substrate to prepare an anode and a cathode.

Then, the anode, the cathode, and a commercially-available NAFION 115 polymer electrolyte membrane were used to fabricate a membrane-electrode assembly.

The membrane-electrode assembly was inserted between glass fiber gaskets coated with polytetrafluoroethylene, and then between two bipolar plates including a gas channel and a cooling channel with a set (or predetermined) shape and compressed between copper end plates, thereby fabricating a fuel cell system with a unit cell.

### EXAMPLE 2

A unit cell was fabricated according to the same (or substantially the same) method as in Example 1 except for using a polytetrafluoroethylene yarn with an average diameter of 1 μm.

### EXAMPLE 3

A unit cell was fabricated according to the same (or substantially the same) method as in Example 1 except for using a polytetrafluoroethylene yarn with an average diameter of 500 nm.

### COMPARATIVE EXAMPLE 1

A unit cell was fabricated according to the same (or substantially the same) method as in Example 1 except for including an electrode substrate formed by immersing a carbon cloth made of carbon fiber in a polytetrafluoroethylene resin solution.

Then, 1 M of methanol and dry air were injected into the fuel cells according to Examples 1 to 3 and Comparative Example 1. Based on their output measurements, the fuel cells according to Examples 1 to 3 were found to have better fuel cell characteristics as compared to that of Comparative Example 1.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An electrode for a fuel cell comprising:
an electrode substrate comprising a carbon fiber and a hydrophobic polymer fiber; and
a catalyst layer on the electrode substrate.

2. The electrode of claim 1, wherein the hydrophobic polymer fiber is weaved with the carbon fiber.

3. The electrode of claim 1, wherein the hydrophobic polymer fiber has an average diameter ranging from about 100 nm to about 10 μm.

4. The electrode of claim 3, wherein the hydrophobic polymer fiber has the average diameter ranging from about 100 nm to about 1 μm.

5. The electrode of claim 1, wherein the carbon fiber and the hydrophobic polymer fiber are mixed in a ratio ranging from about 99:1 to about 50:50 wt %.

6. The electrode of claim 5, wherein the carbon fiber and the hydrophobic polymer fiber are mixed in the ratio ranging from about 95:5 to about 80:20 wt %.

7. The electrode of claim 1, wherein the hydrophobic polymer fiber comprises a resin selected from the group consisting of polytetrafluoroethylene, polyvinylidene fluoride, polyhexafluoropropylene, polyperfluoro alkylvinylether, polyperfluorosulfonylfluoride, alkoxyvinyl ether, fluorinated ethylene propylene, polychlorotrifluoroethylene, copolymers thereof, and combinations thereof.

8. A fuel cell system comprising:
at least one electrical generator comprising a membrane-electrode assembly and generating electricity through electrochemical reaction of a fuel and an oxidant, the membrane-electrode assembly comprising an anode, a cathode facing the anode, and a separator between the anode and the cathode, at least one of the anode or the cathode comprising an electrode substrate and a catalyst layer;
a fuel supplier supplying the at least one electrical generator with a fuel; and
an oxidant supplier supplying the electrical generator with an oxidant,
wherein the electrode substrate comprises a carbon fiber and a hydrophobic polymer fiber.

9. The fuel cell system of claim 8, wherein the hydrophobic polymer fiber is weaved with the carbon fiber.

10. The fuel cell system of claim 8, wherein the hydrophobic polymer fiber has an average diameter ranging from about 100 nm to about 10 μm.

11. The fuel cell system of claim 10, wherein the hydrophobic polymer fiber has the average diameter ranging from about 100 nm to about 1 μm.

12. The fuel cell system of claim 8, wherein the carbon fiber and the hydrophobic polymer fiber are mixed in a ratio ranging from about 99:1 to about 50:50 wt %.

13. The fuel cell system of claim 12, wherein the carbon fiber and the hydrophobic polymer fiber are mixed in the ratio ranging from about 95:5 to about 80:20 wt %.

14. The fuel cell system of claim 8, wherein the hydrophobic polymer fiber comprises a resin selected from the group consisting of polytetrafluoroethylene, polyvinylidene fluoride, polyhexafluoropropylene, polyperfluoroan alkylvinylether, polyperfluorosulfonylfluoride, alkoxyvinyl ether, fluorinated ethylene propylene, polychlorotrifluoroethylene, copolymers thereof, and combinations thereof.

15. A fuel cell electrode comprising:
an electrode substrate comprising a hydrophobic polymer fiber weaved with a carbon fiber; and
a catalyst layer on the electrode substrate.

16. The electrode of claim 15, wherein the hydrophobic polymer fiber has an average diameter ranging from about 100 nm to about 10 μm.

17. The electrode of claim 16, wherein the hydrophobic polymer fiber has the average diameter ranging from about 100 nm to about 1 μm.

18. The electrode of claim 15, wherein the carbon fiber and the hydrophobic polymer fiber are mixed in a ratio ranging from about 99:1 to about 50:50 wt %.

19. The electrode of claim 18, wherein the carbon fiber and the hydrophobic polymer fiber are mixed in the ratio ranging from about 95:5 to about 80:20 wt %.

20. The electrode of claim 15, wherein the hydrophobic polymer fiber comprises a resin selected from the group consisting of polytetrafluoroethylene, polyvinylidene fluoride, polyhexafluoropropylene, polyperfluoro alkylvinylether, polyperfluorosulfonylfluoride, alkoxyvinyl ether, fluorinated ethylene propylene, polychlorotrifluoroethylene, copolymers thereof, and combinations thereof.
